(19) United States
(12) Patent Application Publication
(10) Pub. No.: US 2011/0194995 A1
(43) Pub. Date: Aug. 11, 2011

(54) MICROFLUID DEVICE

(75) Inventors: Andreas Rigler, Weyer (AT); Michael Vellekoop, Hinterbruhl (AT); Bernhard Lendl, Wien (AT)

(73) Assignee: TECHNISCHE UNIVERSITAT WIEN, Wien (AT)

(21) Appl. No.: 13/061,324

(22) PCT Filed: Aug. 27, 2009
(86) PCT No.: PCT/AT2009/000336

§ 371 Date: Apr. 28, 2011

(30) Foreign Application Priority Data
Aug. 28, 2008 (AT) A1335/2008

(51) Int. Cl. B01L 3/00

(52) U.S. Cl. 422/504

(57) ABSTRACT

The present invention relates to a microfluid device for discharging a fluid or a mixture of fluids including a discharge channel, at least one main fluid supply channel which leads into at least one secondary supply channel which is essentially situated in the same plane as the discharge channel, and which leads laterally towards the discharge channel and, in turn, leads into an inlet channel situated above or below the discharge channel, the inlet channel entering into the discharge channel from its top or bottom side via at least one inlet opening. The at least one inlet channel has a cross-sectional shape which changes in the longitudinal direction and/or in that the at least one inlet opening has an opening width changing in the transverse direction of the discharge channel.

The present invention relates to microfluid devices for discharging fluids or fluid mixtures.

It is difficult to produce thoroughly mixed fluid mixtures in systems working with laminar flows, such as microfluid systems, because, mainly due to the lack of turbulences, but also due to the short distances, the supplied fluids are not sufficiently mixed, especially in the case of liquids. The mixing of different fluid streams flowing in a channel is thus almost exclusively limited to diffusion processes. Apart from that, the arrangement of conduits in microfluid application poses problems, as it is difficult to use the third dimension.

DE 19604289 C2, for example, discloses an approach to solving these problems, in which two fluid streams are introduced into a mixing chamber of a so-called micromixer, each on either side of a partition wall, and only mixed later on, in order to form an interface at which diffusion may take place.

The problems concerning the arrangement of conduits and the loss of pressure in the supply conduits and at the points where they enter into the mixing channel, will not be dealt with in the present document.

Referring to the compensation of pressure loss, EP 1.187.671 B1 discloses the introduction of several fluids into a mixing chamber of a “micromixer” via inlet channels having diameters which are adequately tapered in different ways. The channels are tapered in the longitudinal direction, i.e. towards the mixing chamber, and the surface of the inlet openings is perpendicular to the longitudinal axis of the same. The channels cross each other, without contacting, and form a common outlet section at the mixing chamber. In this way, pressure losses in the supply conduits are compensated for. The problem that, due to pressure losses in the transverse direction of a mixing channel, different amounts of fluids are introduced into said mixing channel if they are supplied at its sides, does not occur at all in this embodiment of a microfluid device and, thus, is not even mentioned.

A micromixer presented by Kauffmann E., Darnton N. C., Austin R. H., Blatt C., and Gerwert K. in “Life-times of intermediates in the β-sheet to α-helix transition of β-lactoglobulin by using a diffusional IR mixer”, PNAS 98, 6646-6649, 2001 is schematically illustrated in FIG. 1. Several fluid streams are introduced into a mixing channel (which is vertical in FIG. 1) via supply channels. The supply channels lead towards the mixing channel at one of the sides and of said mixing channel, and enter into it one after the other, at its bottom side, the cross-section of the inlets at the entrance sites being rectangular, i.e. slit-shaped. This way, several laminar fluid streams flowing one over the other are generated, namely one stream per supply channel, whereby diffusion occurs between them in the further course of the mixing channel. In this embodiment of a micromixer pressure losses are not compensated for, so that the supplied amount of fluids varies in the transverse direction of the mixing channel. This means that at the end of the inlet opening which is further removed from the supply (the top end in the figure) the fluid amount entering into the mixing channel is necessarily lower than at the end which is situated closer to the inlet opening (the bottom end). As this holds true for each of the supplied fluids, the mixing quality is poor.

Against this background, it was the task of the present invention to provide a microfluid device with which the above-mentioned problems concerning pressure loss and the arrangement of supply conduits may be overcome.

### SUMMARY OF THE INVENTION

According to the invention, this task is fulfilled by providing a microfluid device for discharging a fluid or a mixture of fluids, said microfluid device comprising a discharge channel, at least one main fluid supply channel which leads into at least one secondary supply channel which is situated essentially within the plane of the discharge channel and leads laterally into said discharge channel and, in turn, leads into an inlet channel which is situated above or below the discharge channel and leads into the discharge channel from below or from above via at least one inlet opening, characterized in that said at least one inlet channel has a cross-sectional shape changing in the longitudinal direction and/or in that the at least one inlet opening has an opening width changing in the transverse direction of the discharge channel.

As the cross-sectional shape of the inlet channel changes in its longitudinal direction and/or the width of the inlet opening(s) changes in the transverse direction of the discharge channel, varying amounts of fluids may be introduced at different sites of the inlet channel from the inlet channel into the discharge channel. Depending on the shape, locally changing pressure conditions are created and, thus, the flow rate and, consequently, the amount of fluid passing the width of the discharge channel are determined. Due to the pressure difference between the two ends of the inlet channel and the inlet opening(s), unequal amounts of fluids introduced into the discharge channel may, for example be adjusted to the same amount by implementing the inlet channel in a way in which it becomes wider towards the remote end, so that a larger interface between the inlet channel and the discharge channel is available for the passage of the fluid. Thus, it is possible to introduce into the discharge channel a fluid layer which is uniformly thick over the entire width of the discharge channel. Depending on the application of the device in pipe systems, it is, however, also possible to introduce into the discharge channel smaller or greater amounts of fluids, such as a fluid gradient, at different sites of the width of the discharge channel, which may not only be useful for mixing purposes, but, for example, also for chemical reactions taking place in this channel.

It has to be noted that, due to the variable location of the discharge channel, which remains variable even after the microfluid device has entered into operation, the above mentioned terms “top” and “bottom” as well as “above” and “below” are used interchangeably and mainly serve the purpose of explaining the embodiments illustrated in the accompanying figures in greater detail.

The fluid(s) is/are not subject to any particular limitations. The fluid(s) may be any flowable material(s) and mixtures of flowable materials. Preferably, the invention is used with liquids or liquid/gas mixtures, as the advantages of the invention become particularly apparent in this connection.

According to the present invention, one or more inlet openings leading into the discharge channel may be provided for each inlet channel. In the first case, the only inlet opening may be formed by the top edges of the inlet channel, the top of which, directed towards the discharge channel, is completely open and may, thus, cover the overall interface between the inlet channel and the discharge channel. This simplifies the manufacturing of such microfluid devices, as will be described in further detail later on. In all embodiments of the invention, the shapes of the inlet channels and the respective inlet openings may be the same or different, which allows for a targeted determination of the amount of fluid entering into the discharge channel at any given site over the entire width of the discharge channel. The inlet channel may, for example, be tapered, for example in a wedge-like shape, or may widen in the area of its point of entrance, while the inlet opening may, for example, have a regular rectangular shape. Alternatively or additionally, several openings, which may be slit-shaped, circular or oval, per inlet channel (which may have a changing cross-sectional shape) may be provided, etc.

The ways in which the cross-sectional shape of the at least one inlet channel and the shape of the at least one inlet opening change are not subject to any particular limitations and may be adapted to the respective applications of the device. The cross-sectional shape preferably changes in a linear way, because this makes it possible to efficiently compensate for the pressure loss over the length of the channel and a uniform distribution of the fluid or the fluid mixtures in the transverse direction of the discharge channel may be guaranteed. The thus resulting fluid streaming behavior may be well simulated and optimized by means of computer programs. As the pressure loss in the channels is exponential, a corresponding exponential change of the channels' cross-sections would, based on purely physical considerations, maybe constitute an even better solution to this problem. In practice, however, significantly higher efforts are required to realize such exponential changes, at least using current manufacturing techniques, which is why they are currently not preferred. Considering the expected progress in the field of manufacturing processes in the years to come, it may, however, soon be possible to produce such cross-sectional shapes requiring only reasonable efforts.

Preferably, the width of the at least one inlet channel increases in the transverse direction of the discharge channel, i.e. at the end, a larger face is available for the fluid's transition from the respective inlet channel into the discharge channel in order to compensate for the decrease in pressure. The width of the inlet channel may increase both at its top edge and at its bottom edge or only at one of them. This means that the inlet channel does not necessarily have to have lateral walls extending perpendicularly to the plane of the discharge channel, as will be further described later on. A changing depth of the channels also has an influence on the introduction of fluids into the discharge channel; if the inlet channels become deeper towards their ends due to a larger cross-sectional area, this, however, tends to increase the pressure loss, while a decreasing depth (and, hence, a smaller cross-sectional area) again compensate for the decrease in pressure.

By means of the shape and structure of the channels, which may, for example be circular or rectangular and have a rough or smooth surface, by means of the length of the channels as well as the shape of the channels, for example forming circular or rectangular branches, the flow rate of the fluid towards the inlet openings may be determined. According to the invention, these means may be used instead of as well as in combination with other regulation means, such as mechanical means, such as micropumps, micro valves, etc.

In other preferred embodiments of the invention, all inlet openings are disposed at the same side of the discharge channel, i.e. above or below it, which is schematically illustrated in the FIGS. 3 and 4, which will be further discussed later on and in which all inlet channels are shown below the discharge channel, leading into the discharge channel. It is easier to produce this arrangement when manufacturing microfluid devices.

In preferred embodiments, the main supply channels lead into several secondary supply channels and the corresponding inlet channels, and it is also preferred that several main supply channels are provided. They preferably include one or more first main supply channels for introducing a first fluid and one or more second main supply channels for introducing a second fluid. This makes it possible to introduce several layers of fluids, also several layers of several fluids, into the discharge channel one above the other, which improves and accelerates the mixing of two or more fluids, as there is more than one interface between the fluids available for the diffusion.

Especially adapted to the manufacturing conditions of microfluid applications, the secondary supply channels and their respective inlet channels for several fluids preferably lead into the discharge channel at opposite sides, as it is hardly possible to dispose the channels one over the other in microfluid devices, as it is difficult to use the third dimension. In order to introduce several layers of several fluids, it is preferred that several first secondary supply channels and inlet channels and several second secondary supply channels and inlet channels lead towards and enter into the discharge channel from opposite sides, intermeshing in a “comb-like” arrangement (which will be described in further detail later on).

The device of the present invention makes it possible to bring together immiscible liquids, so that a dissolved substance from one phase may diffuse into the immiscible other phase. In this application, the device does not serve as a mixer, but as a microextractor.

The device of the invention allows for the controllable mixing of two or several layers of miscible fluids by means of diffusion. Thus, a reproducible time response of the diffusing mixing may be obtained which depends on the characteristics of the fluids used (among other things, on the diffusion coefficient), the flow rate, and the layers' thickness. This way, the mixing quality can be improved compared to the state of the art.

In a second aspect, the present invention concerns the use of an above described device for discharging several fluids which preferably are discharged in the form of layers. The layers may have the same or different thicknesses, as they may be determined by means of the cross-sections of the inlet channels and/or the inlet openings. In the course of discharging, the fluids preferably are at least partially mixed as a result of diffusion at the interfaces between the layers.

### BRIEF DESCRIPTION OF THE FIGURES

The present invention will now be described in further detail referring to the accompanying figures in which:

FIG. 1 is a schematic illustration of a micromixer according to the state of the art which has been described at the beginning of the description;

FIG. 2 is a schematic illustration of an embodiment of the device of the invention for introducing a fluid via a main supply channel branching into two secondary supply channels and inlet channels into a discharge channel;

FIG. 3 is a longitudinal sectional view of the embodiment in FIG. 2 along the line A-A;

FIG. 4 is a cross-sectional view of three possible embodiments of the device in FIG. 2 along the line B-B;

FIG. 5 is a schematic illustration of an embodiment of the device of the invention for introducing two fluids via meshing inlet channels in a “comb-like” arrangement into a discharge channel;

FIG. 6 is a cross-sectional view of the embodiment in FIG. 5;

FIG. 7 is a schematic detailed view of different embodiments of an inlet channel with a changing cross-sectional shape;

FIG. 8 is a schematic detailed view of different embodiments of inlet openings in the inlet channels; and

FIG. 9 is a longitudinal sectional view of alternative embodiments of the device in FIG. 2 along the line A-A.

### DESCRIPTION OF EMBODIMENTS OF THE INVENTION

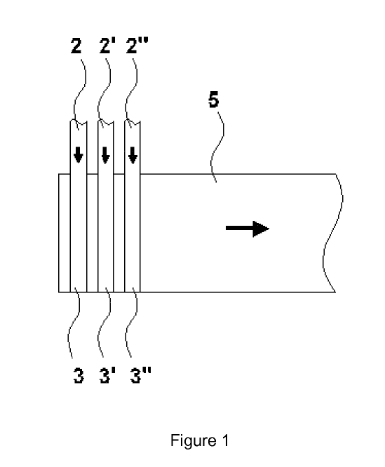

As mentioned above, FIG. 1 shows a known embodiment of a microfluid device according to the state of the art. In this device, three separate supply channels 2, 2′, 2″ for liquids, one after the other, lead into a mixing channel 5 which is illustrated in the vertical direction. In the relevant publication quoted in the beginning, a stream of a liquid sample is introduced into the channel between puffer streams in order to mix them within the channel. The three streams are supplied from the same side of the mixing channel 5—in FIG. 1, seen in the flow direction of the fluid in the mixing channel 5: from the left side—via separate supply channels 2, 2′, 2″ which have to be supplied separately, because it is not possible to provide intersecting conduits. Such a construction is common in the manufacture of microfluid devices and, at the same time, indispensable, because the channels and other components usually are etched, burned, melted or cut into a support. Due to this manufacturing method, the fluid conduits of such microfluid devices are commonly referred to as channels, although they actually constitute closed conduits, as they are covered by a cover plate after the completion of the etching and cutting processes—this is not in line with the way in which the term “channel” is used in other technical fields, for example in the field of constructional engineering.

The field of microfluids is subject to different definitions in literature, but for the purpose of the present invention, it refers to devices of such dimensions which lead to the cross-sectional areas of the channels being in the order of square millimeters or smaller.

One of the problems in connection with such and similar devices, which is solved by the present invention, is that, due to pressure loss, the amounts of fluid entering into the mixing channel at the two ends of the respective inlet channel are different at the two ends.

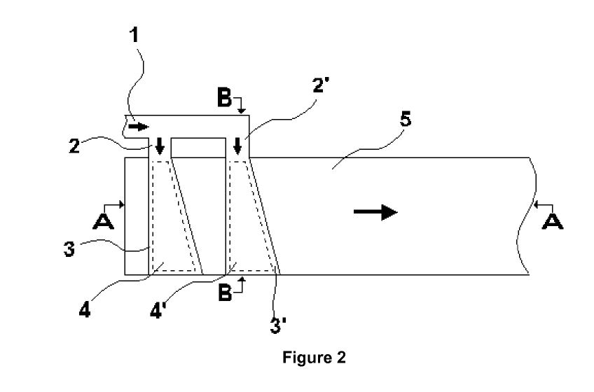

FIG. 2 shows a simple embodiment of the microfluid device of the invention which mainly serves the purpose of illustrating the principle of the invention. In practice, such a device could not serve as a micromixer, but, for example, as a connecting piece between two (micro) conduits leading into two different directions or as a simple channel for discharging fluids (especially liquids), such as in ink jet printers.

In any case, as indicated by the arrows, fluid may be introduced into a discharge channel 5 in the device illustrated in FIG. 2. The fluid is transported through a main supply channel 1 which branches into two secondary supply channels 2, 2′ which, in turn, lead into two inlet channels 3, 3′ to the discharge channel 5 and enters said discharge channel 5 trough inlet openings 4, 4′ (illustrated by dotted lines in all the figures).

The cross-sections of the inlet channels 3, 3′ and the inlet openings 4, 4′ become linearly wider in the areas of their entrance into the discharge channel, which leads to an increase of the pressure loss in the longitudinal direction of the inlet channels, but provides an increasingly larger cross-section for the fluids' transition into the discharge channel 5, which compensates for said pressure loss, depending on the widening angle.

Thus, the present invention makes it possible to compensate for the pressure losses occurring due to longitudinal entrances of conduits and to balance the different fluid amounts discharged as a consequence, the cross-sectional shapes of the inlet channels and the inlet openings being adjustable exactly to the respective conditions.

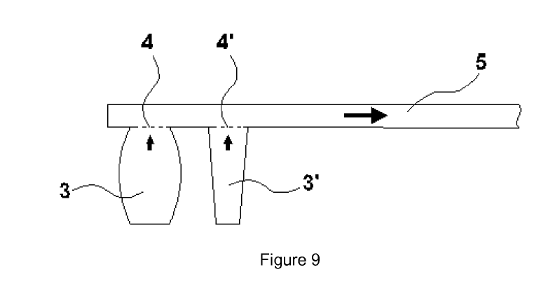

Apart from the cross-sectional shapes of the channels in their longitudinal direction, the cross-sectional shapes in their transverse direction, which may be circular, oval or polygonal, are also significant, so that the lateral wall of the channels do not necessarily have to be parallel and vertical. This also influences the pressure conditions within the respective cross-sections of the channels. Two exemplary embodiments of inlet channels which do not have parallel lateral walls, are illustrated in FIG. 9 and will be further described later on. The main and secondary supply channels may also have such unparallel walls.

According to the present invention, the cross-section of each inlet channel, the cross-section of the respective inlet opening(s) or all of them may change. In all figures, the cross-sections, for example, change in a linear way (“wedge-like”), the course of said change being the same in the inlet channel and the corresponding opening, as is indicated by the parallel lines. In practice, any combination of different cross-sectional shapes may be used, as long as the flow behavior of the fluid(s) in the device of the invention is influenced in a positive way. Apart from linear changes, any other form, such as curvings, waves, corners, edges, toothings and the like, is possible, all of which are included in the scope of the present invention.

As has already been mentioned, when microfluid devices are implemented in practice, there is often no explicit “inlet opening” of the channel 5. The inlet channels rather simply open towards the channel 5 in an entrance area, so that, to a certain extent, there is one single opening 4 covering the entire top surface of the channel 3 in the entrance area.

By means of an adequate construction, especially in the case of slightly larger dimensions in the order of millimeters, several inlet openings per inlet channel may be provided which, again, may have any form. For example, a sequence of slit-like and circular openings—in the longitudinal and/or transverse direction—through which the fluid supplied via the inlet channel enters into the discharge channel at several discrete sites is conceivable and feasible.

A combination of an inlet channel with a linearly tapered cross-section, for example in a wedge-like, conical or curved fashion, and a slit-like inlet opening along the longitudinal direction of the inlet channel with a regular rectangular cross-section is also possible. By means of the tapered cross-section of the channel, the pressure loss towards the remote end of the opening is compensated for, so that the same amount of fluid may enter into the discharge channel at both ends of the opening.

In addition to the changing cross-sectional shape in the entrance area, the cross-section of the supply or inlet channels may also change before its entrance area, in order to influence pressure differences within the supply conduits. This may be done in a way which is known, i.e. like in EP 118,767 B1, which has already been mentioned at the beginning, by means of tapering the channels 1 and/or 2 and 2′ towards the discharge channels 5. Thus, it may be guaranteed that in a main supply channel which branches into several secondary supply channels and the corresponding inlet channels the same amount of fluid is discharged in all inlet channels, which leads to obtaining fluid layers of the same thickness in the discharge channel. On the other hand, it is also possible to specifically discharge different amounts and, thus, to produce several layers of different thickness of the same fluid, if this is advantageous for the respective application. The extent of the pressure loss within the supply or inlet channels depends on their lengths and, thus, on the distance between the points of entrance of the inlet channels into the discharge channel. The cross-sectional changes have to be individually adapted in an adequate way.

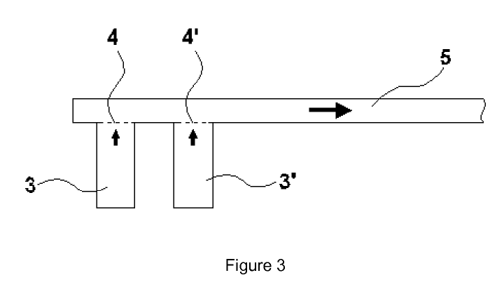

FIG. 3 shows a schematic longitudinal section of the embodiment in FIG. 2 along the line A-A illustrating that the two inlet channels 3 and 3′ enter into the outlet channel 5 at the same side, namely from below. This offers benefits for the manufacturing technique of microfluid devices. Moreover, the lateral walls of the inlet channels 3 and 3′ are parallel. Alternative variations will be described later on referring to FIG. 9.

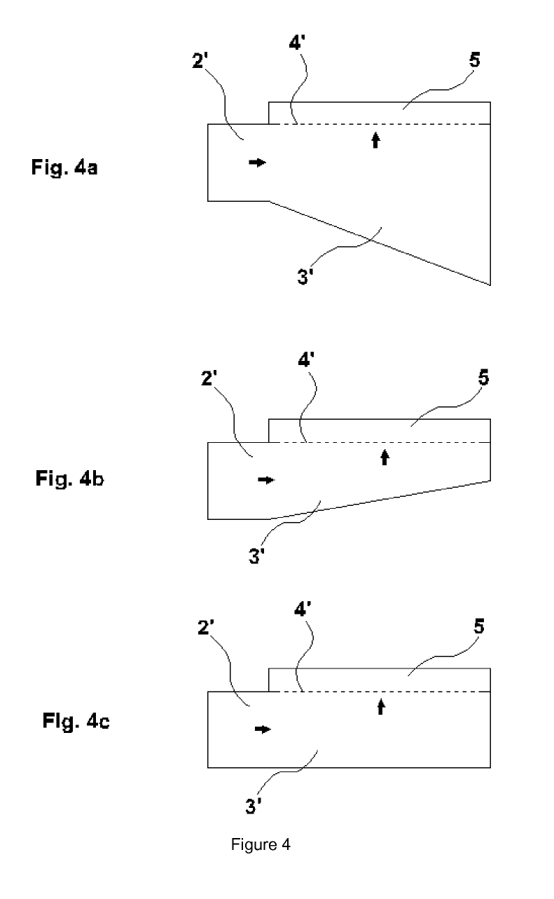

FIG. 4 shows three possible schematic cross-sectional views of the embodiment of FIG. 2 along the line B-B. It can be seen that the cross-section of the inlet channel 3′ may not only become larger in the plane of the discharge channel 5, as shown in FIG. 2, in order to widen in the flow direction of the fluid, but that it may additionally increase or decrease vertically. In FIG. 4a, the inlet channel 3′ becomes deeper over the width of the discharge channel 5, and in FIG. 4b, its depth decreases. In the latter case, an increase in pressure towards the end of the inlet channel 3′ is caused, which compensates for pressure loss in the longitudinal direction of the inlet channel 3′—or which makes it even possible to specifically introduce a fluid amount increasing in this direction into the discharge channel 5. If the inlet channel becomes deeper, as shown in FIG. 4a, the pressure loss is further increased due to the enlargement of the channel's cross-section, so that at the end of the inlet channel 3′, smaller fluid amounts may be specifically introduced into the discharge channel 5. FIG. 4c shows an embodiment in which the depth of the inlet channel 3′ remains constant, which constitutes a preferred embodiment as its manufacturing is easier.

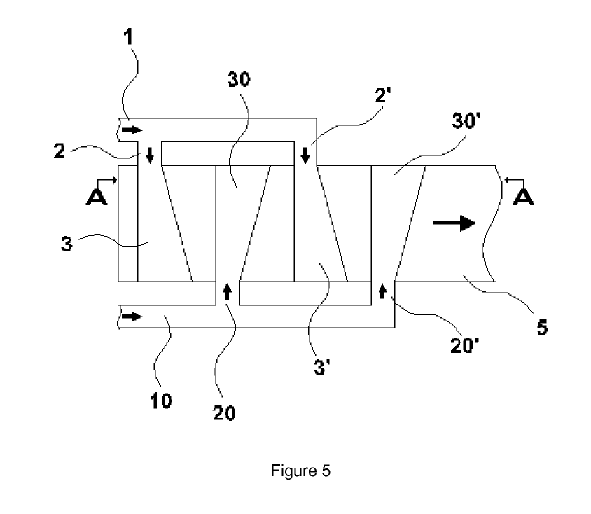

FIG. 5 shows an embodiment of the device of the invention in which two fluids are transported towards the discharge channel 5 from two opposite sides of it. Analogously to the embodiment in FIG. 3, a first fluid is introduced via a main supply channel 1 which leads into two secondary supply channels 2 and 2′ and subsequently into two inlet channels 3 and 3′; a second fluid is introduced via the analogous components 10, 20/20′ and 30/30′. The cross-sectional shapes changing in the entrance areas may again be combined in any way. For a better overview, they are again illustrated as wedge-shaped cross-sections. In order to be able to manufacture such microfluid devices in a space-saving way, the wedge-shaped extensions of the couples of inlet channels 3/30 and 3′/30′ would, in practice, be implemented pointing towards each other, i.e. the channels 30 and 30′ in the figure would not become wider towards their upper right corner, but towards their upper left corner.

It can also be seen that there are no explicit inlet openings provided in this embodiment, as the inlet channels 3/3′ and 30/30′ are open at their upper side towards the discharge channel 5, so that the overall interface towards the discharge channel 5 formed by the upper edges of the inlet channels forms the respective inlet opening.

The four secondary supply channels 2, 2′, 20, 20′ with their inlet channels 3, 3′, 30′, 30 intermesh in a “comb-like” structure, which means that they enter the discharge channel 5 alternately from opposite sides. This way, two layers of the two fluids are alternately introduced into the discharge channel which makes three interfaces available for the diffusion between the two fluids. If there is an even higher number of branches, this effect may be further increased. This significantly accelerates the exchange of substances between the fluids, so that such devices constitute excellent micromixers or—in the case of immiscible liquids—microextractors.

One possible application is the production of microfluid mixtures with a high mixing quality. The optical detection of chemical properties and reactions becomes increasingly important for the development of new drugs. In order to obtain satisfying results, the quick high-quality mixing of fluids is especially important.

The use of more than two fluid layers is useful for the production of such fluid mixtures, in order to minimize the diffusion paths. At the same time, any flows towards any direction other than the flow direction have to be distributed as homogenously as possible over the cross-section of the discharge channel.

In order to achieve this, the device of the invention is used with an aspect relation of 1:10 for the inlet channels and/or inlet openings for many—especially aqueous—fluids. An aspect relation (difference in width:length) of 1:10 here means a widening of the (for example wedge-shaped) channel from, for example, 10.0 μm at the beginning of the inlet channel to 20.0 μm at its end over the length of 100.0 μm of the inlet channel. Thus, a time behavior of the mixing by means of diffusion of two or more fluids which is well reproducible can be achieved, wherein the mixing quality is also significantly influenced by the mixing behavior (the diffusion coefficients) of the fluids as well as by the flow rates.

The embodiment shown in FIG. 5 solves the problem of the pressure difference in the entrance area into the discharge channel in the same way as the above-discussed embodiment illustrated in the FIGS. 2 to 4. At the same time, the supply of two different fluids from opposite sides constitutes a new and advantageous solution for the problem of the arrangement of conduits in microfluid devices. As it is difficult to use the third dimension, it is hardly possible to manufacture overlapping conduits, so that for the supply of several flows of the same fluid several supply channels—not only inlet channels—were required, as has been explained referring to FIG. 1.

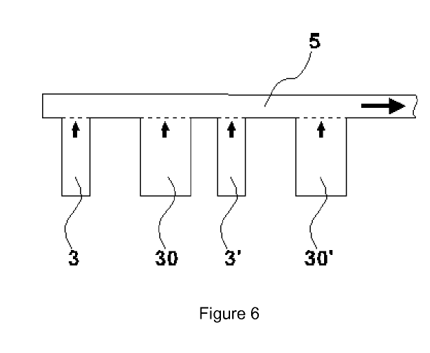

FIG. 6 shows a longitudinal sectional view of the embodiment in FIG. 5 along the line A-A in FIG. 5. This shows that all inlet channels 3, 3′, 30, and 30′ enter into the discharge channel 5 at the same side—again from below. This is beneficial for the procedure for manufacturing microfluid devices in which the channels are etched, cut, etc. into an existing support. As the line A-A in FIG. 5 does not run along the half width of the discharge channel 5, the width of the inlet channel couples 3/3′ and 30/30′ is different due to the different degree of widening at the respective site. The walls of the inlet channels do not necessarily have to be vertical, i.e. perpendicular to the plane of the discharge channel, as illustrated in FIG. 6. The widening or narrowing of the inlet channels towards their bottom end, the fluid amount entering from the respective inlet channel into the discharge channel and, thus, the thickness of the fluid layer at the site of the discharge channel may be controlled. Such a change of the inlet channels' cross-sections is included in the scope of the present invention.

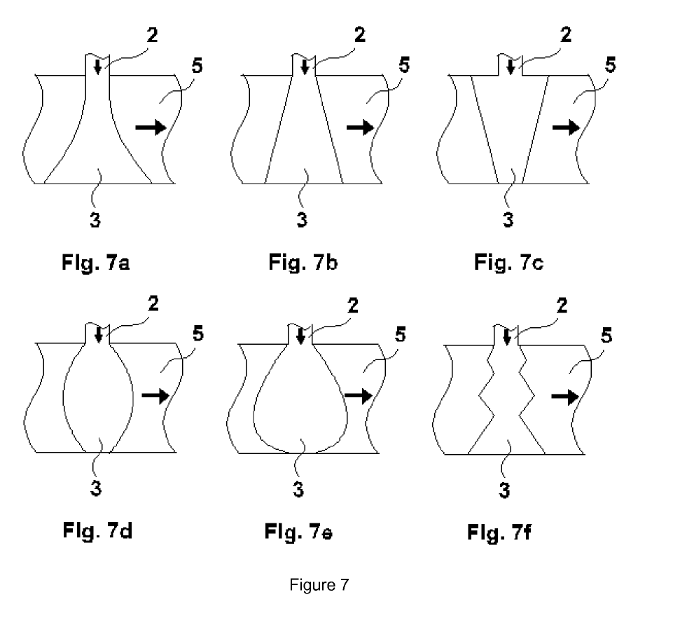

FIG. 7 shows an exemplary schematic illustration of different embodiments of changes of the inlet channels' cross-sections within the plane of the discharge channel. It can clearly be seen that shapes which become wider or narrower over the width of the discharge channel 5 and any combinations thereof as well as combinations of a straight and an oblique or a curved longitudinal wall of the inlet channel 3 are possible. Widening forms are preferred in order to compensate for fluid amounts which are lower due to the pressure loss over the length of the inlet channel 3 and enter into the discharge channel 5 at the inlet channel's 3 end. Such and similar, but also any other changes of cross-sectional shapes are also possible for the depth of the inlet channels, as has already been discussed above. This means that the depth of an inlet channel does not have to increase or decrease linearly either, in order to provide for optimal desired flow conditions for the fluid(s) in the device of the invention.

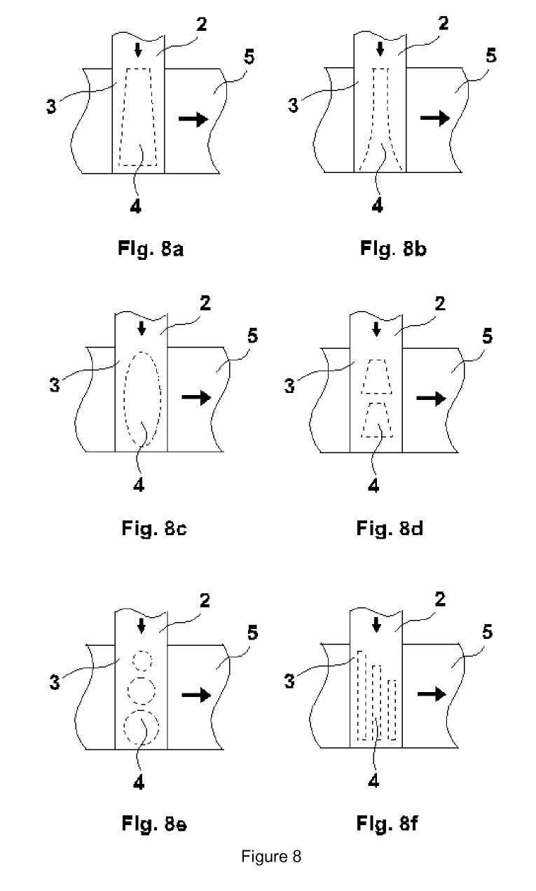

FIG. 8 shows different embodiments of the forms of the inlet openings, the inlet channels being illustrated without changing cross-sections for clarity's sake. Any combination of the embodiments illustrated in the FIGS. 7 and 8 as well as any other embodiments are possible as well, as the invention is not in any way limited to the embodiments shown or described herein.

As has already been discussed, FIG. 9 shows alternative embodiments of the inlet channels 3 and 3′ of FIG. 3 with non-parallel lateral walls which may be combined with any of the above described changes of the channels' cross-sections and opening forms. Channel 3, for example, is illustrated with an oval cross-section, i.e. with lateral walls which are bulged outwards; channel 3′, on the other hand, is illustrated with a cross-section which is tapered towards its bottom end. As has also already been mentioned, additional measures may be taken at the channels' lateral walls, such as providing grooves, roughened areas, corrugations and the like, in order to influence and optimize the flow behavior of the fluids within the channels.

Summarizing it has to be noted that the present invention constitutes a valuable enhancement of the state of the art in the field of microfluids, as it solves existing problems in a relatively simple way by providing devices which may be manufactured in a cost-saving way using known procedures. Thus, there is no doubt concerning the industrial applicability of the present invention.

1. A microfluid device for discharging a fluid or a mixture of fluids comprising a discharge channel, at least one main fluid supply channel which leads into at least one secondary supply channel which is essentially situated in the same plane as the discharge channel, leads laterally towards said discharge channel and, in turn, leads into an inlet channel situated above or below said discharge channel, said inlet channel entering into the discharge channel from its top or bottom side via at least one inlet opening wherein said at least one inlet channel has a cross-sectional shape which changes in the longitudinal direction and/or in that the at least one inlet opening has an opening width changing in the transverse direction of the discharge channel.

2. The device according to claim 1, wherein one inlet opening is provided per inlet channel.

3. The device according to claim 2, wherein the inlet opening is formed by the top edges of the inlet channel, the top of which is entirely open towards the discharge channel.

4. The device according to claim 1, wherein several inlet openings are provided per inlet channel.

5. The device according to claim 1, wherein the width of the at least one inlet channel increases.

6. The device according to claim 1, wherein the depth of the at least one inlet channel increases.

7. The device according to claim 4, wherein all of said inlet openings are disposed at the same side of the discharge channel.

8. The device according to claim 1, wherein the at least one main supply channel leads into several inlet channels via several secondary supply channels.

9. The device according to claim 1, wherein several main supply channels are provided, said main supply channels comprising at least one first main supply channel for introducing a first fluid and at least one second main supply channel for introducing a second fluid.

10. The device according to claim 9, wherein the at least one first main supply channel leads into at least one first inlet channel via at least one first secondary supply channel, and wherein the at least one second main supply channel leads into at least one second inlet channel via at least one second secondary supply channel the first and the second secondary supply channels leading towards the discharge channel at opposite sides.

11. The device according to claim 10, wherein several first secondary supply channels and inlet channels and several second secondary supply channels and inlet channels are provided, said first and second secondary supply channels leading towards and entering into the discharge channel in a comb-like meshing arrangement.
